(19) United States
(12) Patent Application Publication
(10) Pub. No.: US 2012/0101650 A1
(43) Pub. Date: Apr. 26, 2012

(54) METHOD FOR POWER PLANT USAGE PLANNING

(76) Inventors: Thomas Dürr, Erlangen (DE); Paul Hermann, Nurnberg (DE); Wilfried Sicking, Erlangen (DE); Michael Unkelbach, Buckenhof (DE)

(21) Appl. No.: 13/203,300

(22) PCT Filed: Feb. 19, 2010
(86) PCT No.: PCT/EP2010/052085

§ 371 Date: Jan. 6, 2012

(30) Foreign Application Priority Data
Feb. 27, 2009 (DE) 1020090107967

(51) Int. Cl. G05F 5/00

(52) U.S. Cl. 700/292

(57) ABSTRACT

A method for power plant usage planning of a power plant fleet having a plurality of power plants is provided. The current control technology values are supplied to models for lifespan calculations, maintenance information is derived from the lifespan calculations and the maintenance information is taken into consideration in a calculation for power plant usage planning.

### CROSS REFERENCE TO RELATED APPLICATIONS

This application is the US National Stage of International Application No. PCT/EP2010/052085, filed Feb. 19, 2010 and claims the benefit thereof. The International. Application claims the benefits of German application No. 10 2009 010 796.7 DE filed Feb. 27, 2009. All of the applications are incorporated by reference herein in their entirety.

### FIELD OF INVENTION

The invention relates to a method for simulating a power plant fleet with respect to optimal operation by taking control information into consideration.

### BACKGROUND OF INVENTION

Power plants are used within the framework of power plant planning on the basis of financial and technical boundary conditions. FIG. 1 shows a schematic diagram of such power plant usage planning 1 from the prior art.

The environment or the boundary conditions 2 under which power is to be produced form the basis of planning. In addition to supply agreements 3 and the energy demand 4 that is to be anticipated from experience, specific wishes inter alia of customers 5, with which, by way of example, load profiles are agreed which are usually subject to great variations according to the time of day, and which may also differ depending on the day of the week and the season, must also be taken into consideration. Since electrical power can only be stored to a limited degree and with losses, power trading and power production have to follow the time-related variations in power consumption.

In addition to these specifications, conditions 6 such as the operating costs 7 accruing per MWh generated at the respective times, in particular the fuel consumption 8, but also the start-up costs 9, have to be checked. The availability 10 of the individual plant in the fleet also has to be checked. Necessary maintenance work means, by way of example, that the entire fleet cannot be used all the time. A usable load range 11 should also be taken into consideration, i.e. a power plant cannot supply any desired small amount of energy but may only supply between a minimal value, which is not zero, and a maximal value. The conditions to be checked also include weather forecasts 12, in particular wind prognoses for a possible wind farm, and the availability for example of a coal power plant as a secondary reserve 13 or for frequency stabilization 14 for wind power plants (or also fail-over if there is no wind).

Using these specifications a division of the plant of the fleet is defined in a usage schedule 15 with reserve 16.

The actual use of the plant 17 can of course differ from this.

The changed makeup of the new energy mix presents the power plant operators with a new challenge. By way of example, the use of renewable energies has priority, i.e. the previous standard power plants must adapt to the renewable energies. A base power plant becomes a peaker (i.e. frequent changes in load need to be dealt with instead of continuous operation). One drawback of this is that the loading of the affected plant in the fleet increases as does the maintenance expenditure thereof.

### SUMMARY OF INVENTION

The object of the invention is to develop said method for power station usage planning so improved usage planning with an increased lifespan of the plan is achieved.

According to the invention this object is achieved by the method as claimed in the claims. Advantageous developments of the invention are defined in the dependent claims. By supplying current values of a control and protection system to models for lifespan calculations in a method for power plant usage planning of a power plant fleet having a plurality of power plants, deriving maintenance information from the lifespan calculations and taking the maintenance information into consideration in a calculation for power plant usage planning the lifecycle of the main components can be taken into consideration in usage planning and use of the plant can be improved over its lifespan.

Maintenance of a plant which with normal operation of the power plant fleet is due at an inconvenient time interval of power plant usage planning is advantageously brought forward. This ensures that on the one hand maintenance work that is to take place is carried out punctually and, by way of example, at times of lower energy demand and lower power prices, and that the corresponding plant is available at times of high energy demand on the other hand.

It is also advantageous if maintenance of a plant which with normal operation of the power plant fleet is due at an inconvenient time interval of power plant usage planning is deferred, easing the load on the plant. This can be achieved by way of example by more energy being supplied by a different plant in the fleet.

Design and delivery data are expediently taken into consideration in the lifespan calculation. A plant or components of a plant has/have possibly been designed for a different purpose (temperature, pressure, moisture, loads) than is the case during actual operation. High levels of wear and premature failure are to be expected with loads which go beyond the specifications of the components or plant, so maintenance expenditure has to be adjusted.

It is also expedient if historical is are taken into consideration for the lifespan calculation since the overall picture of loading of the respective components or plant is essential for comprehensive maintenance planning.

It is also expedient if models are used for the lifespan calculation.

Sensory data is advantageously used for the lifespan calculation.

It may also be advantageous if empirical values are incorporated in the lifespan calculation.

It is also advantageous if operating hours of a component are taken into consideration for power plant usage planning.

It is also expedient if resources, such a replacement parts, are taken into consideration when determining a maintenance interval.

### BRIEF DESCRIPTION OF THE DRAWINGS

The invention will be exemplarily described in more detail with reference to the drawings, in which schematically and not to scale:

FIG. 1 shows a schematic diagram of power plant usage planning according to the prior art and

FIG. 2 shows power plant usage planning by taking control information into consideration.

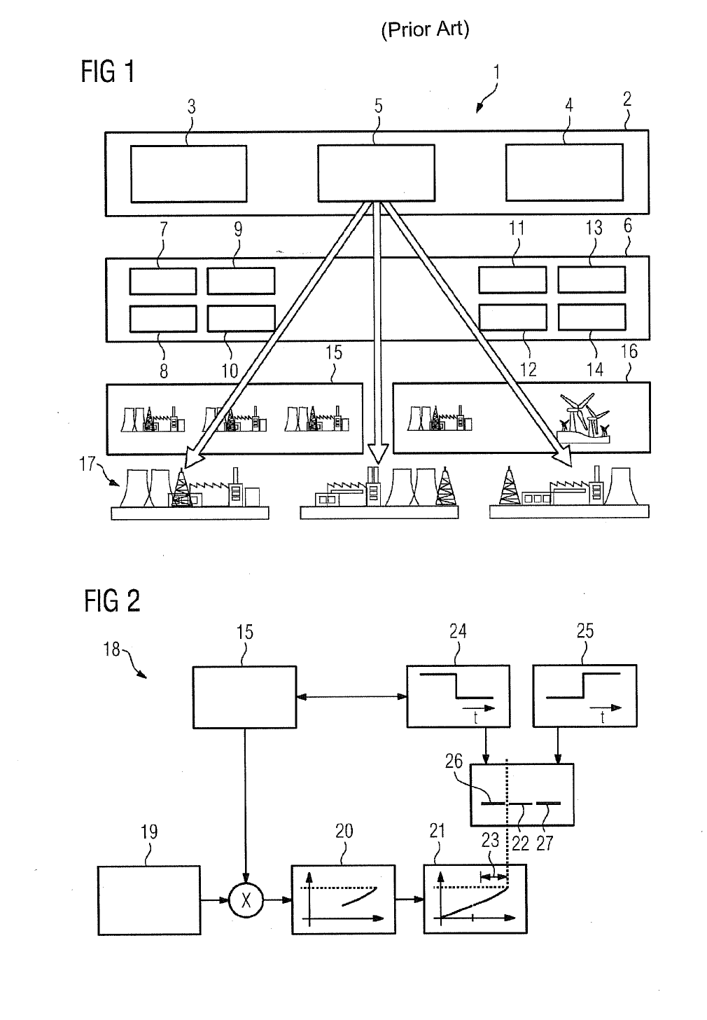

### DETAILED DESCRIPTION OF INVENTION

FIG. 2 schematically shows the inventive power plant usage planning 18. Information from the control and protection system 19 and a provisional power plant usage planning 15 are supplied to models for lifespan calculations 20. Maintenance-relevant data, such as the accumulated number of operating hours of a turbine or boiler in the plant and the number of hours which a component of the plant still has left according to the planned power plant usage plan 15, are taken into consideration in these lifespan calculations 20. Maintenance information 21 for the respective plant can be derived from the lifespan calculations 20. Maintenance 22 can now be punctually planned 23 by taking into consideration the existing resources. Since the anticipated maintenance 21 due date is known, the mathematically determined time for maintenance, for which it is expected the plant must be shut down 24 and then re-started 25, can by way of example be brought forward 26 to a time with a low energy demand or postponed 27 to a later time as a result of correspondingly adjusted operation with the aid of the provisional usage plan 15. In the latter case this can signify a change in provisional power plant usage planning 15 since the lower loading of the plant to be maintained, or its components, must be compensated by other plant in the fleet.

1.-10. (canceled)

11. A method for power plant usage planning of a power plant fleet, comprising:
providing a plurality of power plants;
supplying current values of a control and protection system to models for lifespan calculations;
deriving maintenance information from the lifespan calculations; and
calculating power plant usage planning using the maintenance information.

12. The method as claimed in claim 11, wherein when maintenance of a plant during normal operation of the power plant fleet is due at an inconvenient time interval, using the power plant usage planning the maintenance is brought forward to an earlier time.

13. The method as claimed in claim 11, wherein when maintenance of a plant during normal operation of the power plant fleet is due at an inconvenient time interval, using the power plant usage planning, the maintenance is deferred to a later time, easing a load on the plant.

14. The method as claimed in claim 11, wherein design and delivery data are taken into consideration in the lifespan calculations.

15. The method as claimed in claim 11, wherein historical data is taken into consideration for the lifespan calculations.

16. The method as claimed claim 11, wherein models are used for the lifespan calculations.

17. The method as claimed in claim 11, wherein sensor data is used for the lifespan calculations.

18. The method as claimed in claim 11, wherein empirical values are incorporated in the lifespan calculations.

19. The method as claimed in claim 11, wherein operating hours of a component are taken into consideration for power plant usage planning.

20. The method as claimed in claim 11, wherein resources are taken into consideration when determining a maintenance interval.
